(19) United States
(12) Patent Application Publication
(10) Pub. No.: US 2010/0176335 A1
(43) Pub. Date: Jul. 15, 2010

(54) CMP Slurry Composition for Copper Damascene Process

(75) Inventors: Seok-Ju Kim, Gongju-si (KR); Eun-Il Jeong, Daejeon (KR); Deok-Su Han, Daejeon (KR); Hyu-Bum Park, Yeongi-gun (KR)

Correspondence Address: THE WEBB LAW FIRM, P.C., 700 KOPPERS BUILDING, 436 SEVENTH AVENUE, PITTSBURGH, PA, 15219, US

(73) Assignee: TECHNO SEMICHEM CO., LTD., Seongnam-city (KR)

(21) Appl. No.: 12/663,433

(22) PCT Filed: Jun. 8, 2007
(86) PCT No.: PCT/KR07/02783

§ 371 Date: Mar. 1, 2010

(51) Int. Cl. C09K 13/00

(52) U.S. Cl. 252/79.1

(57) ABSTRACT

The present invention relates to a CMP slurry composition for copper damascene process of semiconductor manufacturing process. The barrier CMP slurry composition for copper damascene process of the present invention does not include an oxidant, so that it exhibits excellent reproducibility of polishing performance, low etching speed, and adequate polishing speed for copper layer, silicon oxide film and Ta-based film. Thus, the slurry composition of the invention has such advantages as easy dishing or erosion removal, excellent dispersion stability, and low scratch level, making it excellent barrier CMP slurry composition for copper damascene process.

### TECHNICAL FIELD

The present invention relates to a CMP slurry composition for copper damascene process of semiconductor manufacturing process, more precisely the barrier CMP slurry composition for copper damascene process.

### BACKGROUND ART

Since copper chip was developed by IBM using damascene process in 1997, the demand of copper instead of tungsten or aluminum has been increasing as a wiring material for overcoming the increase of wiring resistance caused by reduction of wire size on the device. If copper is used as a metal wiring, etching process using plasma is impossible. Therefore, damascene process is required as an alternative and at this time copper CMP (chemical mechanical polishing) process is essential. The importance of copper CMP slurry becomes greater with the increase of semiconductor device having copper wiring.

Copper damascene process comprises the steps of forming a hole and trench for perpendicular and horizontal wiring by patterning the surface of dielectric layer with the conventional dry etching process; coating the patterned surface with an adhesion promoting film made by Ti or Ta, a diffusion barrier film made by TiN or TaN, or a complex film thereof; coating the adhesion promoting film or diffusion barrier film with copper; and chemical mechanical polishing for not only copper but also the adhesion promoting film, diffusion barrier film and silicon oxide film to prepare a hole and trench filled with electroconductive copper and circuit wiring composed of dielectric substance like low-k material. At this time, CMP process is carried out by the following two steps stepwise; the bulk Cu polishing is to eliminate copper layer, in which copper polishing speed is very fast not to extend the polishing to the diffusion barrier film and a slurry with high removal selectivity of copper layer over the diffusion barrier film (at least 100:1); and the barrier polishing is characterized by low removal selectivity of each layer and relatively moderate polishing speed of slurry. In the barrier polishing, the target layer for polishing, specifically Cu layer, TaN/Ta film, and insulating film (for example, silicon oxide film or low dielectric film), etc, is polished. Therefore, polishing speed of each layer, at least three layers, has to be adequate so as to eliminate dishing or erosion developed during the bulk Cu polishing to produce evenly polished surface. Dishing indicates the phenomenon that the central part of metal wiring like copper wiring is excessively eliminated. Erosion indicates the development of unnecessary concave portion on the surface caused by the elimination of a part of insulating layer with high density of metal wiring. Neither dishing nor erosion is necessary for circuit, because they both cause inferiority of electrical properties.

A slurry composition for the barrier polishing of copper layer is described in Korean Patent No. 10-0473442, in which Ta-based polishing composition is prepared using fumed silica, propanoic acid and hydrogen peroxide and the first solution containing an abrasive and the second solution containing an oxidant are separately packed to prevent time-dependent decomposition of hydrogen peroxide. However, the individually packed slurry compositions make the process complicated. In addition, Korean Patent Publication No. 2003-59070 describes the slurry composition containing basic fumed silica by using propanoic acid as an organic acid. This composition is characterized by improved storage stability resulted from fumed silica. However, hydrogen peroxide included therein might be a threat for storage stability because there is still a possibility of time-dependent decomposition of hydrogen peroxide under basic condition, which also makes the control of copper layer polishing speed and selectivity difficult and reproducibility of polishing performance unsecured.

In the meantime, Korean Patent Publication No. 2005-39602 provides a method for copper polishing in which copper is polished by CMP stepwise by using a polishing liquid containing 0.1-5 weight % of abrasive and 0.5-10 weight % of citric acid or glutamic acid as an organic acid but not containing an oxidant. However, the polishing liquid therein provides very low polishing speed for silicon oxide film, which might cause dishing of copper wiring on the copper layer. As an example of selective elimination of Ta-based film, Korean Patent Publication No. 2004-104956 describes the slurry for Ta barrier elimination containing a formamidine-based or guanidine-based Ta eliminator. Korean Patent Publication No. 2005-43666 provides the polishing liquid for Ta-based barrier elimination comprising azol compound and an abrasive. However, this polishing liquid exhibits too low polishing speed for copper layer and silicon oxide film to be useful as barrier CMP composition for copper damascene process.

To overcome problems of the conventional methods, the present inventors studied hard to provide the slurry for the barrier polishing of copper that does not contain an oxidant to secure storage stability of the slurry and reproducibility of polishing performance. As a result, the inventors discovered that the addition of such abrasives and additives as a) organic phosphoric acid or its salt, or b) one or more compounds selected from the group consisting of gluconic acid, morpholin, taurine, adipic acid and amino alcohol or their salts, or c) one or more compounds selected from the group consisting of gluconic acid, morpholin, taurine, adipic acid, citric acid and amino alcohol or their salts in addition to organic phosphoric acid or its salt can lower etching speed of copper, can regulate the polishing speed of copper layer, insulating layer and Ta-based film, can reduce dishing or erosion of copper wiring caused during the bulk Cu polishing process and can secure dispersion stability. Then, the present inventors completed this invention by confirming the slurry composition having the above composition can be effectively used for the barrier polishing of copper damascene process.

### DISCLOSURE

### Technical Problem

It is an object of the present invention to provide a slurry composition for barrier CMP of copper damascene process which does not include an oxidant to secure excellent reproducibility of polishing performance without time course changes.

It is another object of the present invention to provide a slurry composition for the barrier CMP of copper damascene process that has adequate polishing speed for copper layer, silicon oxide film and Ta-based film so as to provide excellent flatness and reduce dishing or erosion caused during the bulk Cu CMP.

It is a further object of the present invention to provide a slurry composition for the barrier CMP of copper damascene process that has satisfactory polished level of copper layer surface and less scratch development.

### Technical Solution

The present invention provides a CMP slurry composition for copper damascene process.

The present invention provides a CMP slurry composition which includes, as abrasives and additives, a) organic phosphoric acid or its salt, or b) one or more compounds selected from the group consisting of gluconic acid, morpholin, taurine, adipic acid and amino alcohol or their salts, or c) one or more compounds selected from the group consisting of gluconic acid, morpholin, taurine, adipic acid, citric acid and amino alcohol or their salts in addition to organic phosphoric acid or its salt, but does not include an oxidant.

The slurry for the barrier CMP for copper damascene process of the present invention does not include an oxidant, so it provides excellent reproducibility of polishing performance but no time course changes as well as provides low copper etching speed. In addition, this slurry of the invention enables regulation of polishing speed of copper layer, insulating layer (silicon oxide film or low dielectric film) and Ta-based film, so that it reduces dishing and erosion caused during the bulk Cu polishing, making it an excellent candidate for slurry composition for barrier CMP for copper damascene process.

The slurry composition of the present invention is characterized by not containing any of oxidants generally used such as hydrogen peroxide, potassium iodate, ammonium persulfate, potassium ferricyanide, potassium bromate, vanadium trioxide, hypochlorous acid, sodium hypochlorite and ferric nitrate. Hydrogen peroxide, the most common oxidant used for the semiconductor process, is decomposed time-dependently under the basic condition, causing variations in polishing speed or polishing selectivity. However, the slurry composition of the present invention does not include any oxidant, so it provides excellent reproducibility of polishing performance but no time course changes and adequate polishing speed for copper and silicon oxide film during the barrier polishing of copper damascene process. Exclusion of an oxidant eliminates the mixing procedure of the slurry and an oxidant, making the slurry supplying equipment simple and useful.

Hereinafter, the present invention is described in detail.

An abrasive included in the slurry plays a role in regulating polishing speed of Ta-based film and silicon oxide film. The polishing speed of Ta-based film and silicon oxide film increases with the increase of abrasive content. The abrasive is exemplified by fumed silica, colloid silica, alumina, ceria, zirconium oxide, zeolite and their mixture. Among these compounds, fumed silica or colloid silica is more preferred as an abrasive. The lower the abrasive content, the higher the dispersibility and the less the scratch generates. But, if the abrasive content is too low, the polishing speed of silicon oxide film and Ta-based film goes down very low. So, the preferable abrasive content is determined as 0.5-12 weight % and 1-10 weight % is more preferable and 3-8 weight % is most preferable content, considering dispersibility and scratch development. The preferable mean diameter of an abrasive is 20-300 nm. Again, if the abrasive size is too small, the polishing speed reduces, whereas if the abrasive size is too large, scratches are easily made.

As explained hereinabove, an additive for the composition of the invention can be selected from the group consisting of a) organic phosphoric acid or its salt, or b) one or more compounds selected from the group consisting of gluconic acid, morpholin, taurine, adipic acid and amino alcohol or their salts, or c) one or more compounds selected from the group consisting of gluconic acid, morpholin, taurine, adipic acid, citric acid and amino alcohol or their salts in addition to organic phosphoric acid or its salt.

First, a) organic phosphoric acid or its salt plays a role in inhibition of defects such as corrosion and scratches on copper layer caused during CMP. Copper has very low hardness, suggesting that it gets scratches easily. Copper also has very low chemical stability, indicating that it gets easily corroded. Therefore, in order to produce semiconductor device equipped with copper wiring, scratch development, dishing and erosion have to be overcome. The present inventors discovered that the addition of an organic phosphoric acid or its salt to the barrier copper CMP composition reduces erosion and dishing on copper layer, and at the same time improves dispersibility that makes difference in scratch development.

In the case of adding a conventional organic acid, an corrosion inhibitor has to be added to prevent corrosion. However, in the case of adding an organic phosphoric acid or its salt according to the present invention, an corrosion inhibitor is not necessarily added to prevent corrosion.

The preferable organic phosphoric acid or its salt is the compound having one or more primary, secondary and tertiary amine groups represented by the following formulas 1 and 2.

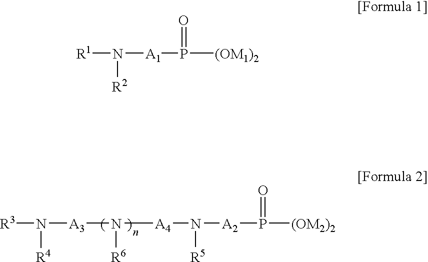

Wherein, R¹-R⁶ are independently H, C₁-C₈ alkyl or B₁—P(O)(OM₃)₂; A₁-A₄ and B₁ are independently C₁-C₆ alkylene; n is 0 or 1; and M₁-M₃ are independently H, ammonium, sodium or potassium.

The organic phosphoric acid is preferably 2-aminoethyl phosphoric acid, nitrilotris(methylene)triphosphonic acid (NTPA, N[CH₂P(O)(OH)₂]₃) diethylenetriaminepenta(methylenephosphonic acid), hexamethylenediaminetetra(methylenephosphonic acid), or ethylenediaminetetra(methylenephosphonic acid) (EDTMP). One of those compounds or a mixture thereof can be selected as an organic phosphoric acid. Ethylenediaminetetra(methylenephosphonic acid) represented by formula 3 is more preferred since this compound can reduce scratch generation, lower the defects such as corrosion owing to its low etching speed, and does not need an corrosion inhibitor or if necessary need a minimum content of the corrosion inhibitor.

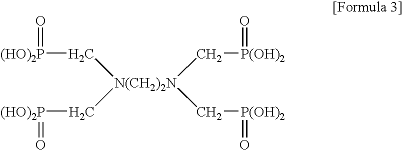

The preferable concentration of organic phosphoric acid or its salt for the total weight of the slurry is 0.001-1 weight % and 0.01-0.5 weight % is more preferred. If the content is less than 0.001 weight %, defects such as corrosion and scratch cannot be successfully inhibited, whereas if the content is more than 1 weigh %, the gelation of the slurry will be observed with the decrease of fluidity.

Aminoalcohol can be additionally added to the slurry composition containing the organic phosphoric acid or its salt of a). The addition of aminoalcohol results in the decrease of the surface defects of Ta-based film and silicon oxide film and the improvement of dispersion stability of the slurry in addition to the decrease of adhesion of the slurry particles onto the copper layer. However, high aminoalcohol content might reduce dispersibility and interrupt the prevention of adhesion of polishing particles as well as reduce polishing speed of copper and silicon oxide. On the contrary, low aminoalcohol content cannot contribute to elimination of particles and rather lowers dispersion stability. So, the preferable concentration of aminoalcohol for the total slurry weight is 0.001-2 weight % and 0.01-0.5 weight % is more preferred.

The applicable aminoalcohol is exemplified by 2-amino-methyl-1-propanol (AMP), 3-amino-1-propanol, 2-amino-1-propanol, 1-amino-2-propanol, 1-amino-pentanol, 2-(2-aminoethylamino)ethanol, 2-dimethylamino-2-methyl-1-propanol, N,N-diethylethanolamine, monoethanolamine, diethanolamine, triethanolamine, etc, but not always limited thereto and these compounds can be used separately or as a mixture.

Second, as an additive, one or more compounds selected from the group consisting of b) gluconic acid, morpholin, taurine, adipic acid and amino alcohol or their salts can be used. This additive is to control polishing speed of copper layer and Ta-based film and to improve dispersibility of the slurry composition, and to inhibit the adhesion of polishing particles. In the above b), taurine and gluconic acid or their salts are preferred because polishing speed ratio of Ta-based film to copper layer is high and copper etching speed is low as well with these compounds. The preferable content of the additive b) is 0.001-5 weight % and 0.01-1.0 weight % is more preferred and 0.01-0.4 weight % is most preferred. If the content is regulated between the range of 0.001-5 weight %, polishing speeds of copper layer, Ta-based film and silicon oxide film can be adequately regulated and dispersion stability can be improved. But, if the content is more than 5 weight %, copper etching speed will be increased.

Third, as an additive, one or more compounds selected from the group consisting of c) one or more compounds selected from the group consisting of gluconic acid, morpholin, taurine, adipic acid, citric acid and amino alcohol or their salts in addition to organic phosphoric acid and its salt can be used. For example, when citric acid or its salt and nitrilotris(methylene)triphosphonic acid (NTPA) or its salt are used together, polishing speed of Ta-based film is increased, polishing speed ratio of Ta-based film to copper layer is increased, and copper layer etching speed is reduced. The preferable concentration of a compound or its salt selected from the group consisting of gluconic acid, morpholin, taurine, adipic acid, citric acid and amino alcohol of c) is 0.001-0.5 weight % and 0.01-0.4 weight % is more preferred. The preferable content of organic phosphoric acid or its salt of c) is 0.001-1.0 weight % and 0.001-0.4 weight % is more preferred. The addition of organic phosphoric acid or its salt of c) and a compound or its salt selected from the group consisting of gluconic acid, morpholin, taurine, adipic acid, citric acid and amino alcohol to the slurry results in the inhibition of adhesion of polishing particles, improvement of dispersibility and increase of polishing speed of Ta-based film. However, overdose of organic phosphoric acid of c) might cause corrosion of copper layer and break of dispersion stability to cause micro-scratches on the copper surface. On the contrary, if the content is lower than the above preferable range, the effect of the addition of organic phosphoric acid is in doubt. A compound or its salt selected from the group consisting of gluconic acid, morpholin, taurine, adipic acid, citric acid and amino alcohol of c) is preferably added less than 0.5 weight % when it is co-used with organic phosphoric acid, otherwise it causes corrosion on the copper layer and reduces polishing speed. Particularly, when the content of the compound is less than 0.001 weight %, adhesion of polishing particles increases but polishing speed for Ta-based film is reduced, which is not desirable.

Aminoalcohol of b) or c) is exemplified by 2-amino-2-methyl-1-propanol (AMP), 3-amino-1-propanol, 2-amino-1-propanol, 1-amino-2-propanol, 1-amino-pentanol, 2-(2-aminoethylamino)ethanol, 2-dimethylamino-2-methyl-1-propanol, N,N-diethylethanolamine, monoethanolamine, diethanolamine, and triethanolamine, etc, but not always limited thereto and these compounds can be added separately or as a mixture. More preferable aminoalcohol is monoethanolamine, 2-amino-2-methyl-1-propanol, 2-dimethylamino-2-methyl-1-propanol or a mixture thereof.

The pH of the slurry composition of the present invention is 2-12 and preferably 2-5 and 8-12, and more preferably 9-11. To adjust pH within the above range, a pH regulator can be added and at this time any pH regulator can be used. Herein, a basic pH regulator can be selected from the group consisting of potassium hydroxide, ammonium hydroxide, tetramethylammonium hydroxide and a mixture thereof. An acidic pH regulator can be selected from the group consisting of nitric acid, hydrochloric acid, sulfuric acid, perchloric acid, and phosphoric acid. The addition of a basic pH regulator complementarily improves dispersion stability of fumed silica and colloid silica added as an abrasive to increase zeta potential. Ammonium hydroxide is functioning to increase polishing speed of copper. If pH is lower than the above range, dispersibility of an abrasive decreases. If pH is too low or too high, dissolution of copper is observed. If the pH is regulated within 5-8, dispersion stability is weakened.

The slurry composition of the present invention causes less corrosion, and thus an corrosion inhibitor is not necessarily added but a minimum content of the corrosion inhibitor can be added. The corrosion inhibitor such as benzotriazol is strongly bonded to copper to form a hydrophobic copper surface, resulting in the decrease of cleaning ability to cause defects or problems of particle adhesion or scratches, which might be a serious problem for copper damascene process. The slurry composition of the present invention does not include an oxidant, so that corrosion is significantly reduced, suggesting that there is no need to add an corrosion inhibitor. But if necessary to reduce defects on copper surface, a minimum concentration of an corrosion inhibitor can be added but at this time problems caused by overdose of an corrosion inhibitor are still inhibited. The acceptable corrosion inhibitor can be selected from azol compounds such as benzotriazole, 5-aminotetrazol, 1-alkyl-5-aminotetrazol, 5-hydroxy-tetrazol, 1-alkyl-5-hydroxy-tetrazol, tetrazol-5-thiol, imidazole. Among azol compounds, benzotriazole, 5-aminotetrazol or 1-alkyl-5-aminotetrazol is preferred. Azol compounds can be used separately or as a mixture. The preferable concentration of azol compound is 0.0001-0.1 weight % and 0.005-0.05 weight % is more preferred. The content more than 0.1 weight % results in the decrease of polishing speed of copper, whereas the content less than 0.0001 weight % cannot guarantee the corrosion inhibiting effect.

A surfactant can be additionally added to the slurry composition by 0.0001-0.01 weight % for the total weight of the slurry. The surfactant is added to improve wetness of the hydrophobic layer having low dielectric constant or might change polishing speed for the low dielectric film. If the content of such surfactant is too low, the effect will be in doubt and if the content of the surfactant is too high, too many bubbles will be generated.

The slurry composition for the barrier CMP of copper damascene process of the invention is characterized by excluding an oxidant, having 8-12 of pH, based on the total weight of slurry, containing an abrasive by 0.5-12 weight %, and containing an additive selected from the group consisting of a) 0.001-1 weight % of organic phosphoric acid or its salt; b) 0.001-5 weight % of one or more compounds selected from the group consisting of gluconic acid, morpholin, taurine, adipic acid and amino alcohol or their salts; and c) 0.001-0.5 weight % of one or more compounds selected from the group consisting of gluconic acid, morpholin, taurine, adipic acid, citric acid and amino alcohol or their salts in addition to organic phosphoric acid or its salt.

The more preferable slurry compositions of the present invention can be grouped into three according to additives.

The slurry composition of group 1 is, based on the total weight of slurry, preferably composed of 1-10 weight % of fumed silica or colloid silica as an abrasive; 0.01-0.5 weight % of ethylenediaminetetra(methylenephosphonic acid) (EDTMP) or nitrilotris(methylene)triphosphonic acid (NTPA) as organic phosphoric acid; and a pH regulator selected from the group consisting of ammonium hydroxide, potassium hydroxide or a mixture thereof. This composition has characteristically 8-12 of pH and if necessary 0.01-0.5 weight % of aminoalcohol selected from the group consisting of monoethanolamine, 2-amino-2-methyl-1-propanol and 2-(2-aminoethylamino)ethanol can be added. An corrosion inhibitor and a surfactant can also be added.

The slurry composition of group 2 is, based on the total weight of slurry, preferably composed of 1-10 weight % of fumed silica or colloid silica; 0.01-1.0 weight % of one or more compounds or their salts selected from the group consisting of taurine, gluconic acid, 2-amino-2-methyl-1-propanol and monoethanolamine; and a pH regulator such as potassium hydroxide or ammonium hydroxide to adjust pH to 8-12. An corrosion inhibitor or a surfactant can be additionally added, if necessary.

The slurry composition of group 3 is, based on the total weight of slurry, preferably composed of 1-10 weight % of fumed silica or colloid silica; 0.01-0.4 weight % of one or more compounds or their salts selected from the group consisting of citric acid, 2-amino-2-methyl-1-propanol, and monoethanolamine; 0.001-0.4 weight % of nitrilotris(methylene)triphosphonic acid (NTPA); and a pH regulator such as potassium hydroxide or ammonium hydroxide to adjust pH to 8-12. An corrosion inhibitor or a surfactant can be additionally included.

### MODE FOR INVENTION

Practical and presently preferred embodiments of the present invention are illustrative as shown in the following Examples.

However, it will be appreciated that those skilled in the art, on consideration of this disclosure, may make modifications and improvements within the spirit and scope of the present invention.

### EXAMPLES

The sample wafer for polishing was the copper wafer deposited with copper by 10000 Å using PVD. The sample wafer for Ta-based film was the wafer deposited with TaN thin film by 5000 Å. The sample wafer for silicon oxide film was the wafer deposited with PETEOS thin film by 10000 Å. The polishing apparatus was Poli500CE of G&P Technology. The polishing pad for polishing test was IC1400 of Rodel Co.

Conditions for polishing performed in Examples 1-7 are as follows; Table/Head speed was 30/30 rpm, polishing pressure was 100 g/cm², amount of slurry provided was 200 ml/min and polishing time was 60 seconds. The thickness of the copper layer and TaN thin film was calculated by converting sheet resistance measured with four point probe surface resistance meter (Changmin Tech., Korea) into thickness. The thickness of PETEOS thin film was measured by Spectra Thick 4000 of K-mac. To measure etching speed, the copper wafer was dipped in polishing liquid for 5 minutes at room temperature and then washed to measure the thickness. The surface of the copper was observed under floodlight and scanning electron microscope (SEM) after polishing and etching to investigate scratches and adhesion of abrasive particles as well as corrosion.

The conditions for polishing in Examples 8-12 are as follows; Table/Head speed was 60/60 rpm, polishing pressure was 200 g/cm², amount of slurry provided was 200 ml/min and polishing time was 60 seconds. To measure etching speed, the copper wafer was dipped in polishing liquid for 10 minutes at room temperature and then washed to measure the thickness.

### Example 1

As shown in Table 1, colloid silica A (mean diameter: 45 nm), colloid silica B (mean diameter: 80 nm) or fumed silica (surface area: 200 m²/g) was used as an abrasive. The compositions and contents of additives are as shown in Table 1 and pH was regulated by KOH.

TABLE 1

| | | | | Polishing Speed | | | Cu Etching |
|---|---|---|---|---|---|---|---|
| Experiment | | | | (Å/min) | | | Speed |
| No. | Abrasive | Additive | pH | Cu | TaN | PETEOS | (Å/min) |
| 1-1 | Colloid | Gluconic | 10.9 | 182 | 408 | 670 | 4.0 |
| | Silica A | Acid | | | | | |
| | 10% | 0.4% | | | | | |
| 1-2 | Colloid | Gluconic | 10 | 203 | 670 | 543 | 3.3 |
| | Silica B | Acid | | | | | |
| | 10% | 0.4% | | | | | |
| 1-3 | Colloid | NTPA | 9.5 | 309 | 1232 | 679 | <1 |
| | Silica A | 0.2% | | | | | |
| | 10% | Citric | | | | | |
| | | acid | | | | | |
| | | 0.4% | | | | | |
| 1-4 | Fumed | Gluconic | 10 | 146 | 497 | 397 | 3.0 |
| | Silica | Acid | | | | | |
| | 8% | 0.4% | | | | | |
| 1-5 | Fumed | Monoethanolamine | 10 | 235 | 441 | 264 | 2.5 |
| | Silica | 0.03% | | | | | |
| | 8% | | | | | | |
| 1-6 | Fumed | Morpholin | 10 | 235 | 464 | 368 | <1 |
| | Silica | 0.4% | | | | | |
| | 8% | | | | | | |
| 1-7 | Fumed | Taurine | 10 | 305 | 724 | 458 | 4.2 |
| | Silica | 0.4% | | | | | |
| | 8% | | | | | | |
| 1-8 | Fumed | Adipic | 10 | 165 | 555 | 470 | 14 |
| | Silica | Acid | | | | | |
| | 8% | 0.4% | | | | | |

The results of investigation of polishing speed of the slurry composition are shown in Table 1. As shown in Table 1, the slurry composition of the invention regulates polishing speed adequately even under low pressure and slow spinning speed and keeps etching speed very low by excluding an oxidant, suggesting that defects by corrosion can be inhibited. Thus, the slurry composition of the invention is useful as the barrier CMP composition for copper damascene process.

Neither scratches nor corrosion was observed on the polished copper wafer. Corrosion was not observed, either on the copper wafer tested for etching speed. In general, if an oxidant is added, an corrosion inhibitor has to be added enough, otherwise etching speed becomes accelerated. However, if an corrosion inhibitor is added to prevent corrosion by fast etching, other defects such as scratches or hydrophobic organic film are formed on the surface, resulting in the poor cleaning ability.

### Example 2

A slurry composition was prepared using 9 weight % of fumed silica with the surface area of 200 m²/g and 0.03% of AMP in addition to the compositions shown in Table 2. pH of this composition was regulated to 10 by KOH.

TABLE 2

| | | | | | | | | Adhesion |
|---|---|---|---|---|---|---|---|---|
| | | | | | | Scratches | Corrosion | of |
| | | | | | | of | of | abrasive |
| | | | | | Cu | copper | copper | particles |
| | | Polishing Speed | | | Etching | surface | surface | on |
| Experiment | | (Å/min) | | | Speed | after | after | copper |
| No. | Composition | Cu | TaN | PETEOS | (Å/min) | polishing | etching | surface |
| 2-1 | BTA | 29 | 465 | 259 | 1.2 | ⊚ | ⊚ | ⊚ |
| | 0.02% | | | | | | | |
| | Monoethanolamine | | | | | | | |
| | 0.03% | | | | | | | |
| 2-2 | Gluconic | 56 | 99 | 345 | 1.9 | ⊚ | ⊚ | ⊚ |
| | Acid | | | | | | | |
| | 0.1% | | | | | | | |
| | BTA | | | | | | | |
| | 0.02% | | | | | | | |
| | Monoethanolamine | | | | | | | |
| | 0.03% | | | | | | | |
| 2-3 | Gluconic | 44 | 364 | 430 | 2.5 | ⊚ | ⊚ | ⊚ |
| | Acid | | | | | | | |
| | 0.4% | | | | | | | |
| | BTA | | | | | | | |
| | 0.02% | | | | | | | |
| | Monoethanolamine | | | | | | | |
| | 0.03% | | | | | | | |
| 2-4 | Gluconic | 489 | 301 | 350 | 11.2 | ⊚ | ⊚ | ⊚ |
| | Acid | | | | | | | |
| | 0.1% | | | | | | | |
| | BTA | | | | | | | |
| | 0.02% | | | | | | | |
| | Monoethanolamine | | | | | | | |
| | 0.03% | | | | | | | |
| | ammonium | | | | | | | |
| | hydroxide | | | | | | | |
| | 0.03% | | | | | | | |
| 2-5 | Gluconic | 307 | 550 | 475 | 4.9 | ⊚ | ⊚ | ⊚ |
| | Acid | | | | | | | |
| | 0.4% | | | | | | | |
| | Monoethanolamine | | | | | | | |
| | 0.01% | | | | | | | |

⊚: Excellent,
Δ: Good,
X: Bad

As shown in Experiment Nos. 2-2 and 2-3, when the gluconic acid concentration was increased from 0.1% to 0.4%, the polishing speed for TaN was comparatively high, suggesting that polishing speed ratio of TaN to copper layer could be regulated. And when ammonium hydroxide was added, the polishing speed of both copper and TaN was increased.

### Example 3

A slurry composition comprising 8 weight % of colloid silica (mean diameter: 45 nm), 0.2 weight % of NTPA, 0.4% of citric acid and water was prepared. pH of the slurry composition was regulated to 9.5 by KOH. As shown in Table 3, monoethanolamine (MEA) was added with the regulation of its content and then copper layer, TaN film and PETEOS film were tested for polishing speed and etching speed.

TABLE 3
Polishing speed according to MEA content

| | | | | | | | | Adhesion |
|---|---|---|---|---|---|---|---|---|
| | | | | | | Scratches | Corrosion | of |
| | | | | | | of | of | abrasive |
| | | | | | Cu | copper | copper | particles |
| | Weight | Polishing Speed | | | Etching | surface | surface | on |
| Experiment | % of | (Å/min) | | | Speed | after | after | copper |
| No. | monoethanolamine | Cu | TaN | PETEOS | (Å/min) | polishing | etching | surface |
| 3-1 | 0 | 309 | 1232 | 679 | <1 | ⊚ | ⊚ | Δ |
| 3-2 | 0.02 | 261 | 1219 | 657 | 6.2 | ⊚ | ⊚ | ⊚ |
| 3-3 | 0.2 | 213 | 1036 | 574 | 11 | ⊚ | ⊚ | ⊚ |
| 3-4 | 2 | 232 | 242 | 201 | 10 | ⊚ | ⊚ | ⊚ |

⊚: Excellent,
Δ: Good,
X: Bad

As shown in Table 3, polishing speed according to MEA content for each film was in the acceptable range, and the polishing speed of TaN and PETEOS was reduced with the monoethanolamine content of 2 weight %. This result indicates that relative polishing speed can be regulated by controlling the content of monoethanolamine. In addition, the addition of monoethanolamine reduced the adhesion of silica particles used as an abrasive onto the copper surface, which means the amount of remaining abrasive particles could be significantly decreased.

### Example 4

A slurry comprising 10 weight % of colloid silica (mean diameter: 80 nm) and 0.4 weight % of gluconic acid was prepared. pH-dependent polishing speed for each film and etching speed of copper layer were measured. To the slurry composition were added 0.03% of AMP and 0.1 weight % of monoethanolamine and polishing speed and etching speed were investigated with changing pH.

TABLE 4

| | | | | | | | | | Adhesion |
|---|---|---|---|---|---|---|---|---|---|
| | | | | | | | Scratches | Corrosion | of |
| | | | | | | | of | of | abrasive |
| | | With or | | | | Cu | copper | copper | particles |
| | | without | Polishing | | | Etching | surface | surface | on |
| Experiment | | AMP and | Speed (Å/min) | | | Speed | after | after | copper |
| No. | pH | monoethanolamine | Cu | TaN | PETEPS | (Å/min) | polishing | etching | surface |
| 4-1 | 3.0 | Without | 131 | 528 | 609 | <1 | ⊚ | Δ | X |
| 4-2 | 4.6 | Without | 121 | 503 | 589 | 6.9 | ⊚ | ⊚ | Δ |
| 4-3 | 7.3 | Without | 147 | 184 | 481 | 3.2 | ⊚ | ⊚ | Δ |
| 4-4 | 10.5 | Without | 421 | 301 | 465 | 2.2 | ⊚ | ⊚ | Δ |
| 4-5 | 2.9 | With | 101 | 542 | 617 | 6.9 | ⊚ | Δ | Δ |
| 4-6 | 5.9 | With | 67 | 370 | 374 | 1.3 | ⊚ | ⊚ | ⊚ |
| 4-7 | 8.0 | With | 138 | 451 | 528 | 5.8 | ⊚ | ⊚ | ⊚ |
| 4-8 | 10.0 | With | 203 | 670 | 543 | 3.3 | ⊚ | ⊚ | ⊚ |

⊚: Excellent,
Δ: Good,
X: Bad

As shown in Table 4, the addition of aminoalcohol reduced the adhesion of abrasive particles onto the copper layer. Gelation was observed partially in some slurries added with AMP and monoethanolamine under ph 5-8. So, preferable pH range was determined to be between 2-5 and 8-10.

### Example 5

A slurry comprising 8 weight % of fumed silica (surface area: 200 m²/g) and 0.03 weight % of AMP was prepared. pH of the slurry was regulated to 10 by KOH. As shown in Table 5, the polishing speed and etching speed of copper layer, TaN and PETEOS films were investigated under different compositions and contents of additives. The surface of copper was also observed.

TABLE 5

| | | | | | | | | | Adhesion |
|---|---|---|---|---|---|---|---|---|---|
| | | | | | | | Scratches | Corrosion | of |
| | | | | | | | of | of | abrasive |
| | | | | | | Cu | copper | copper | particles |
| | | | Polishing | | | Etching | surface | surface | on |
| Experiment | | | Speed (Å/min) | | | Speed | after | after | copper |
| No. | Additive | Additive % | Cu | TaN | PETEPS | (Å/min) | polishing | etching | surface |
| 5-1 | Gluconic | 0.05 | 60 | 744 | 306 | <1 | ⊚ | ⊚ | ⊚ |
| | Acid | | | | | | | | |
| 5-2 | Gluconic | 0.2 | 214 | 715 | 369 | 1.2 | ⊚ | ⊚ | ⊚ |
| | Acid | | | | | | | | |
| 5-3 | Gluconic | 0.4 | 146 | 497 | 397 | 3.0 | ⊚ | ⊚ | ⊚ |
| | Acid | | | | | | | | |
| 5-4 | Adipic | 0.05 | 232 | 439 | 361 | 2.6 | ⊚ | ⊚ | ⊚ |
| | Acid | | | | | | | | |
| 5-5 | Adipic | 0.2 | 195 | 502 | 420 | 4.9 | ⊚ | ⊚ | ⊚ |
| | Acid | | | | | | | | |
| 5-6 | Adipic | 0.4 | 165 | 555 | 470 | 14.4 | ⊚ | ⊚ | ⊚ |
| | Acid | | | | | | | | |
| 5-7 | Taurine | 0.05 | 120 | 866 | 120 | <1 | ⊚ | ⊚ | ⊚ |
| 5-8 | Taurine | 0.2 | 252 | 573 | 361 | 2.4 | ⊚ | ⊚ | ⊚ |
| 5-9 | Taurine | 0.4 | 305 | 729 | 458 | 4.2 | ⊚ | ⊚ | ⊚ |
| 5-10 | Morpholin | 0.05 | 225 | 465 | 313 | 1.9 | ⊚ | ⊚ | ⊚ |
| 5-11 | Morpholin | 0.2 | 228 | 419 | 336 | <1 | ⊚ | ⊚ | ⊚ |
| 5-12 | Morpholin | 0.4 | 235 | 464 | 368 | <1 | ⊚ | ⊚ | ⊚ |

⊚ Excellent,
Δ: Good,
X: Bad

As shown in Table 5, taurine or gluconic acid was appropriate to be added for slurry composition for the barrier CMP owing to its high polishing speed for TaN. The polishing speed ratio of TaN to Cu could be regulated by the content of an additive.

### Example 6

### Time Course Changes

As shown in Table 6, the slurry compositions prepared in Examples 1-5 were tested for particle size and pH to examine time course changes respectively in early preparation, 20 days and 2 months after preparation. The mean diameter was measured by Horiba particle size distribution analyzer and the results are shown in Table 6. The composition of Experiment No. 6-1 was equal to that of Experiment No. 5-3 except that 0.2% of NTPA and 0.4% citric acid were used instead of 0.4% of gluconic acid.

TABLE 6

| | | Early | | 20 days after | | 60 days after | |
|---|---|---|---|---|---|---|---|
| | | preparation | | preparation | | preparation | |
| | Additive | Mean | | Mean | | Mean | |
| Experiment | and | diameter | | diameter | | diameter | |
| No. | content | (NM) | pH | (NM) | pH | (NM) | pH |
| 5-3 | Gluconic | 92 | 10.0 | 92 | 9.97 | 93 | 9.99 |
| | Acid 0.4% | | | | | | |
| 5-6 | Adipic | 93 | 10.0 | 92 | 9.99 | 94 | 9.98 |
| | Acid 0.4% | | | | | | |
| 6-1 | NTPA 0.2% + | 92 | 10.0 | 93 | 9.98 | 92 | 9.99 |
| | citric | | | | | | |
| | acid 0.4% | | | | | | |
| 5-9 | Taurine | 91 | 10.0 | 92 | 9.97 | 93 | 9.91 |
| | 0.4% | | | | | | |
| 5-12 | Morpholin | 91 | 10.0 | 92 | 9.96 | 94 | 9.98 |
| | 0.4% | | | | | | |

As shown in Table 6, mean diameter and pH were hardly changed by the addition of the additive shown in Table 6 even after 60 days from the preparation, suggesting that dispersion stability and pH time course stability of the compositions of the invention are excellent. The slurry composition of the present invention does not include an oxidant, so pot life time and shelf life time are equally excellent, that is pot life time is comparatively extended.

### Example 7

### Evaluation of Dishing Removal Ability

SKW 6-3 pattern wafer of SKW was used to evaluate dishing removal ability. The pattern wafer used in this example was prepared by forming 5000 Å trench pattern on PETEOS film and deposited with Ta/TaN by 250 Å/250 Å, Cu Seed by 1000 Å, and electroplating Cu by 15,000 Å. The pattern comprises copper wiring and PETEOS insulating line and the width of the copper wiring was regulated in the range of 10-100 μm. Profiles were recorded by alpha step apparatus of KLA-Tencor and dishing value was calculated by the following calculation formula.

[Calculation Formula]

Dishing value=Height of PETEOS line area−Height of the concave portion of Cu line wiring

The pattern wafer was polished with the bulk Cu CMP slurry of the general copper damascene process. The slurry of Example 3 (Experiment No. 3-2) was used as the barrier CMP slurry. In Table 6, the value at 0 second of the barrier CMP indicates the degree of dishing caused by the bulk Cu CMP process. The width of the wiring (Cu/PETEOS) “50 μm/1 μm” indicated in Table 5 indicates the width of copper wiring is 50 um and the width of the neighboring PETEOS wiring is 1 μm.

TABLE 7
Dishing value according to polishing time

| | |
|---|---|
| Width of | |
| wiring | Polishing time (sec) |

| (Cu/PETEOS) | 0 | 60 | 120 | 180 |
|---|---|---|---|---|
| 100 μm/100 μm | 915 Å | 494 Å | 235 Å | 21 Å |
| 50 μm/50 μm | 784 Å | 421 Å | 236 Å | 52 Å |
| 10 μm/10 μm | 223 Å | 58 Å | 27 Å | 8 Å |
| 50 μm/1 μm | 175 Å | 138 Å | 101 Å | 63 Å |

As shown in Table 7, dishing was reduced over the time after the bulk Cu CMP as the barrier CMP process proceeded, suggesting that excellent flatness was expected.

### Example 8

A slurry composition comprising 8 weight % of fumed silica, 0.1 weight % of ethylenediaminetetra(methylenephosphonic acid) (EDTMP) and water was prepared. pH of the slurry was adjusted to 9.6 by KOH (Experiment No. 8-1). The slurries, according to Experiment Nos. 8-6-8-9, were prepared by comprising 1-8 weight % of colloid silica (mean diameter: 70 nm).

TABLE 8

| | | | | | Cu |
|---|---|---|---|---|---|
| | | Polishing | | | Etching |
| Experiment | | Speed (Å/min) | | | Speed |
| No. | Composition (Weight %) | Cu | TaN | PETEOS | (Å/min) |
| 8-1 | Fumed silica 8%, EDTMP 0.1%, | 812 | 2743 | 777 | <1 |
| | pH = 9.6 | | | | |
| 8-2 | Fumed silica 8%, EDTMP 0.1%, | 2628 | 3000 | 686 | 5 |
| | NH₃ 0.05%, pH = 9.6 | | | | |
| 8-3 | Fumed silica 8%, EDTMP 0.1%, | 831 | 2772 | 790 | <1 |
| | AMP 0.05%, pH = 9.6 | | | | |
| 8-4 | Fumed silica 8%, EDTMP 0.1%, | 464 | 1905 | 772 | <1 |
| | NH₃ 0.05%, AMP 0.05%, | | | | |
| | BTA0.001%, pH = 9.6 | | | | |
| 8-5 | Fumed silica 8%, EDTMP 0.1%, | 391 | 1429 | 906 | <1 |
| | NH₃ 0.05%, AMP 0.05%, | | | | |
| | BTA0.001%, pH = 10.5 | | | | |
| 8-6 | Colloid silica 1%, EDTMP | 164 | 390 | 29 | <1 |
| | 0.1%, AMP 0.05%, BTA0.002%, | | | | |
| | pH = 9 | | | | |
| 8-7 | Colloid silica 3%, EDTMP | 208 | 820 | 62 | <1 |
| | 0.1%, AMP 0.05%, BTA0.002%, | | | | |
| | pH = 9 | | | | |
| 8-8 | Colloid silica 5%, EDTMP | 240 | 1210 | 123 | <1 |
| | 0.1%, AMP 0.05%, BTA0.002%, | | | | |
| | pH = 9 | | | | |
| 8-9 | Colloid silica 8%, EDTMP | 320 | 1467 | 245 | <1 |
| | 0.1%, AMP 0.05%, BTA0.002%, | | | | |
| | pH = 9 | | | | |

As shown in Table 8, the slurry composition of Experiment No. 8-1 exhibits high speed of TaN elimination and is adequate for regulating the polishing speed for copper layer and silicon oxide film (PETEOS), so that it can be effectively used as a barrier slurry composition for copper damascene process. Moreover, the slurry composition does not include any oxidant so that etching speed can be kept as low, suggesting that defects by corrosion can also be inhibited.

As confirmed in the composition of Experiment No. 8-2, when ammonia was added, polishing speed for metal film such as copper and TaN film increased and etching speed for copper also increased slightly. On the other hand, when benzotriazol (BTA) was added, polishing speed for metal film decreased. So, it was confirmed that polishing speed of each film could be regulated by the addition of ammonia or BTA.

### Example 9

A slurry composition comprising 8 weight % of fumed silica, 0.05 weight % of AMP, 0.05 weight % of ammonia, 0.001% of BTA and water was prepared. pH of this slurry was regulated to 9.6 by KOH. As shown in Table 9, the polishing speed for copper, TaN and PETEOS films was investigated with the regulation of EDTMP content.

TABLE 9
EDTMP dependent polishing speed

| | | | | | Scratches | |
|---|---|---|---|---|---|---|
| | | | | | of copper | |
| | | Polishing Speed | | | surface | Corrosion of |
| Experiment | Weight % | (Å/min) | | | after | copper surface |
| No. | of EDTMP | Cu | TaN | PETEOS | polishing | after etching |
| 9-1 | 0 | 470 | 2319 | 542 | Many | High |
| 8-4 | 0.1 | 464 | 1905 | 772 | Little | Low |
| 8-10 | 0.5 | 435 | 1369 | 934 | Little | Low |
| 8-11 | 1 | 413 | 1752 | 852 | Little | Low |

As shown in Table 9, EDTMP dependent polishing speed for each film was all in the acceptable range. Gelation of slurry was observed with the content of EDTMP of 2 weight %. When EDTMP was added, scratch generation on the copper surface finished with CMP was inhibited and corrosion on the copper surface after etching was also inhibited, suggesting that defects on the surface could be reduced.

### Example 10

### The Effect of AMP Content

A slurry composition comprising 8 weight % of fumed silica, 0.1 weight % of EDTMP, 0.05% of ammonia, 0.001% of BTA and water was prepared and pH of this composition was adjusted to 9.6 by KOH (Experiment No. 8-4). As shown in Table 10, AMP dependent polishing speed for copper and silicon oxide films (PETEOS) was investigated. The adhesion of abrasive particles on the copper layer was also observed under scanning electron microscope (SEM). As a result, adhesion of abrasive particles was significantly inhibited.

TABLE 10

| | | | | Adhesion |
|---|---|---|---|---|
| | | | | of abrasive |
| | | | | particles |
| Experiment | Weight % of | Polishing Speed (Å/min) | | on copper |
| No. | AMP | Cu | PETEOS | surface |
| 8-4 | 0.05 | 464 | 772 | ⊚ |
| 8-12 | 0.1 | 562 | 866 | ⊚ |
| 8-13 | 0.3 | 313 | 672 | ⊚ |
| 8-14 | 0.5 | 201 | 397 | ⊚ |
| 8-15 | 0.8 | 123 | 118 | Δ |
| 8-16 | 1.0 | 97 | 18 | Δ |

⊚ Excellent,
Δ: Good,
X: Bad

When AMP content was 0.05-0.5 weight %, adhesion of abrasive particles was significantly inhibited.

### Example 11

The slurry compositions of Experiment Nos. 8-1 and 8-4 were prepared and tested for particle size distribution to examine time course changes, in early preparation and 2 months after preparation. The number of particles (≧1 μm) was measured by Accusizer 780 and the mean diameter was measured by Horiba particle size distribution analyzer, and the results are shown in Table 11.

TABLE 11

| | Number of particles | | | |
|---|---|---|---|---|
| | (≧1 μm) | | Mean diameter (NM) | |
| | | 2 months | | 2 months |
| Experiment | Early | after | Early | after |
| No. | preparation | preparation | preparation | preparation |
| 8-1 | 1020 | 971 | 147 | 147 |
| 8-4 | 1017 | 863 | 147 | 147 |

As shown in Table 11, the slurry composition of the present invention exhibited no increases in particle numbers and mean diameter of the particles even after two months from the preparation, suggesting that the composition has excellent dispersion stability.

### Example 12

### Evaluation of Dishing and Erosion Removal Abilities

Dishing and erosion removal abilities were evaluated using SKW 6-3 pattern wafer of SKW by the same method as described in Example 7. The slurry of Experiment No. 8-4 was used as a barrier CMP slurry. Profiles were investigated by alpha step apparatus of KLA-Tencor and the sum of the two values of dishing and erosion was calculated by the following calculation formula.

[Calculation Formula]

Value of (dishing+erosion)=Height of PETEOS area−Height of concave portion of Cu/PETEOS wiring

In the above formula, Cu/PETEOS wiring indicates the pattern in which copper and PETEOS are repeated each other.

TABLE 12
Value of (dishing + erosion) according to
polishing time

| Width of | | | | | |
|---|---|---|---|---|---|
| wiring | Polishing time (sec) | | | | |
| (Cu/PETEOS) | 0 | 30 | 60 | 90 | 120 |
| 100 μm/100 μm | 947 Å | 737 Å | 438 Å | 217 Å | −319 Å |
| 50 μm/50 μm | 955 Å | 689 Å | 357 Å | 79 Å | −321 Å |
| 10 μm/10 μm | 159 Å | 198 Å | 125 Å | 64 Å | −108 Å |
| 90 μm/10 μm | 908 Å | 430 Å | 187 Å | −161 Å | −343 Å |
| 10 μm/90 μm | 142 Å | 133 Å | 79 Å | 70 Å | −145 Å |

As shown in Table 12, the value of (dishing+erosion) resulted from the bulk Cu CMP was gradually decreased over the time as barrier CMP process proceeded. The value of (dishing+erosion) was low in the time range of 60-120 seconds, suggesting that excellent flatness could be guaranteed in that time range.

### INDUSTRIAL APPLICABILITY

The present invention relates to a slurry composition for barrier CMP of copper damascene process, which does not contain an oxidant. Since the slurry composition of the invention does not include any oxidant, defects such as polishing property changes caused by oxidant dependent time course changes can be inhibited and regular polishing properties can be maintained for a long time. In addition, corrosion by an oxidant is also inhibited, suggesting that defects of copper layer can be inhibited. The slurry composition of the present invention exhibits appropriate polishing speed for copper layer, Ta-based film and silicon oxide film with providing excellent flatness and has advantage of eliminating defects such as dishing and erosion. The slurry composition of the invention also has excellent time course stability and dispersion stability so that large particle formation over the long term storage can be inhibited, suggesting that scratches caused by large particle formation can be inhibited and excellent polished copper surface can be guaranteed by reduced corrosion.

1. A CMP (chemical mechanical polishing) slurry composition for copper damascene process, which is characteristically comprising, based on the total weight of slurry, 0.5-12 weight % of an abrasive and an additive selected from the following a)-c), and has pH of 2-12, but does not include an oxidant.
a) 0.001-1 weight % of organic phosphoric acid or its salt;
b) 0.001-5 weight % of one or more compounds or their salts selected from the group consisting of gluconic acid, morpholin, taurine, adipic acid and amino alcohol; or
c) 0.001-0.5 weight % of one or more compounds or their salts selected from the group consisting of gluconic acid, morpholin, taurine, adipic acid, citric acid and amino alcohol in addition to 0.001-1.0 weight % of organic phosphoric acid or its salt.

2. The CMP slurry composition for copper damascene process according to claim 1, wherein the abrasive is selected from the group consisting of fumed silica, colloid silica, alumina, ceria, zirconium oxide, zeolite and a mixture thereof.

3. The CMP slurry composition for copper damascene process according to claim 2, wherein the abrasive is fumed silica or colloid silica and the content of the abrasive is 1-10 weight %.

4. The CMP slurry composition for copper damascene process according to claim 1, wherein pH is regulated by a pH regulator selected from the group consisting of potassium hydroxide, ammonium hydroxide, tetramethylammonium hydroxide, nitric acid, hydrochloric acid, sulfuric acid, perchloric acid, phosphoric acid and a mixture thereof.

5. The CMP slurry composition for copper damascene process according to claim 1, wherein the aminoalcohol of b) or c) is selected from the group consisting of 2-amino-2-methyl-1-propanol, 3-amino-1-propanol, 2-amino-1-propanol, 1-amino-2-propanol, 1-amino-pentanol, 2-(2-aminoethylamino)ethanol, 2-dimethylamino-2-methyl-1-propanol, N,N-diethylethanolamine, monoethanolamine, diethanolamine, triethanolamine and a mixture thereof.

6. The CMP slurry composition for copper damascene process according to claim 5, wherein the aminoalcohol of b) or c) is selected from the group consisting of monoethanolamine, 2-amino-2-methyl-1-propanol, 2-dimethylamino-2-methyl-1-propanol and a mixture thereof.

7. The CMP slurry composition for copper damascene process according to claim 1, wherein the organic phosphoric acid or its salt of a) or c) is selected from the group consisting of the compounds represented by the following formula 1 and formula 2. 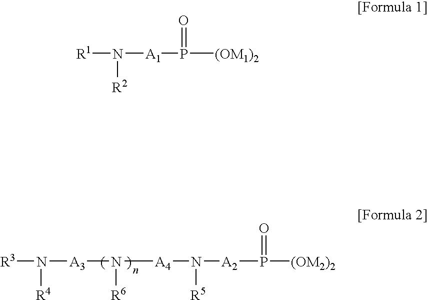
Wherein, R¹-R⁶ are independently H, C₁-C₈ alkyl or B₁—P(O)(OM₃)₂; A₁-A₄ and B₁ are independently C₁-C₆ alkylene; n is 0 or 1; and M₁-M₃ are independently H, ammonium, sodium or potassium.

8. The CMP slurry composition for copper damascene process according to claim 7, wherein the organic phosphoric acid of a) or c) is one or more compounds selected from the group consisting of 2-aminoethyl phosphoric acid, nitrilotris(methylene)triphosphonic acid, diethylenetriaminepenta(methylenephosphonic acid), hexamethylenediaminetetra(methylenephosphonic acid) and ethylenediaminetetra(methylenephosphonic acid).

9. The CMP slurry composition for copper damascene process according to claim 7, wherein the aminoalcohol is additionally included in a) by 0.001-2 weight % for the total weight of the slurry.

10. The CMP slurry composition for copper damascene process according to claim 9, wherein the aminoalcohol of a) is selected from the group consisting of 2-amino-2-methyl-1-propanol, 3-amino-1-propanol, 2-amino-1-propanol, 1-amino-2-propanol, 1-amino-pentanol, 2-(2-aminoethylamino)ethanol, 2-dimethylamino-2-methyl-1-propanol, N,N-diethylethanolamine, monoethanolamine, diethanolamine, triethanolamine and a mixture thereof and is additionally added by 0.01-0.5 weight % for the total weight of the slurry.

11. The CMP slurry composition for copper damascene process according to claim 10, which characteristically comprises 1-10 weight % of fumed silica or colloid silica; 0.01-0.5 weight % of ethylenediaminetetra(methylenephosphonic acid) or nitrilotris(methylene)triphosphonic acid; potassium hydroxide or ammonium hydroxide to regulate pH to 8-12; and 0.01-0.5 weight % of monoethanolamine or 2-amino-2-methyl-1-propanol.

12. The CMP slurry composition for copper damascene process according to claim 1, which characteristically comprises 0.5-12 weight % of fumed silica or colloid silica; and 0.001-5 weight % of one or more additive compounds or their salts selected from the group consisting of gluconic acid, morpholin, taurine, adipic acid and amino alcohol, and has pH of 2-12.

13. The CMP slurry composition for copper damascene process according to claim 12, which characteristically comprises 1-10 weight % of fumed silica or colloid silica; 0.01-1.0 weight % of one or more additive compounds or their salts selected from the group consisting of taurine, gluconic acid, 2-amino-2-methyl-1-propanol and monoethanolamine; and potassium hydroxide or ammonium hydroxide to regulate pH to 8-12.

14. The CMP slurry composition for copper damascene process according to claim 1, which characteristically comprises 0.5-12 weight % of fumed silica or colloid silica; 0.001-0.5 weight % of one or more compounds or their salts selected from the group consisting of gluconic acid, morpholin, taurine, adipic acid, citric acid and amino alcohol; and 0.001-1.0 weight % of nitrilotris(methylene)triphosphonic acid or its salt and has pH of 2-12.

15. The CMP slurry composition for copper damascene process according to claim 14, which characteristically comprises 1-10 weight % of fumed silica or colloid silica; 0.01-0.4 weight % of one or more compounds or their salts selected from the group consisting of citric acid, 2-amino-2-methyl-1-propanol, monoethanolamine; and 0.01-0.4 weight % of an additive selected from the group consisting of nitrilotris(methylene)triphosphonic acid (NTPA) and its salt; and potassium hydroxide or ammonium hydroxide to regulate pH to 8-12.

16. The CMP slurry composition for copper damascene process according to any of claim 9, claim 12 or claim 14, which additionally includes 0.0001-0.1 weight % of an corrosion inhibitor selected from the group consisting of benzotriazole, 5-aminotetrazol, 1-alkyl-5-aminotetrazol, 5-hydroxy-tetrazol, 1-alkyl-5-hydroxy-tetrazol, tetrazol-5-thiol, imidazole and a mixture thereof.

17. The CMP slurry composition for copper damascene process according to claim 16, wherein the corrosion inhibitor is benzotriazole.

18. A method for preparing semiconductor device, which is characterized by including the barrier CMP process for copper damascene process using the slurry composition of claim 1.
